(19) United States
(12) Patent Application Publication
(10) Pub. No.: US 2024/0316406 A1
(43) Pub. Date: Sep. 26, 2024

(54) METHODS AND SYSTEMS FOR CONTROLLING RESISTANCE TRAINING MACHINE

(71) Applicant: Speede Fitness, LLC, Lake Zurich, IL (US)

(72) Inventors: Daniel Mooney, Lake Zurich, IL (US); Gregory Tepas, Barrington, IL (US)

(21) Appl. No.: 18/678,233

(22) Filed: May 30, 2024

Related U.S. Application Data
(63) Continuation of application No. PCT/US2022/051356, filed on Nov. 30, 2022.
(60) Provisional application No. 63/284,412, filed on Nov. 30, 2021.

(51) Int. Cl. A63B 24/00; A63B 21/00; A63B 21/002; A63B 21/005

(52) U.S. Cl. CPC A63B 24/0062; A63B 21/002; A63B 21/0058; A63B 21/153; A63B 2024/0093; A63B 2220/58; A63B 2220/833; A63B 2225/02; A63B 2225/20; A63B 2230/62

(57) ABSTRACT

Provided herein are Methods and Systems For Controlling Resistance Training Machine that provides varying force and velocity levels for isokinetic and isotonic exercises, respectively, for a user.

### CROSS-REFERENCE TO RELATED APPLICATIONS

The present application claims priority to PCT application serial no. PCT/US2022/051356, filed Nov. 30, 2022, which claims priority to U.S. provisional application Ser. No. 63/284,412, filed Nov. 30, 2021, each herein incorporated by reference in their entireties.

### BACKGROUND

The invention generally relates to methods and systems for controlling a resistance training machine.

Resistance training is a form of exercise undergone to build muscular strength and endurance by working against a weight or applied force. While some resistance training routines can be accomplished without external equipment, i.e. bodyweight exercises, many others require the use of specialized equipment, such as but not limited to free weights, weight machines, cable machines, resistance bands, and the like.

Traditional resistance training equipment is often specialized and, while each piece of equipment may offer distinct advantages, each may also suffer from drawbacks and inefficiencies. For example, free weights and weight machines are commonly employed for isotonic exercises, i.e. exercises requiring muscle activation against a constant force across a given range of motion. However, adjusting the weight or force for such exercises can be inconvenient, often requiring a user to add or remove plates, install clips, swap out dumbbells, etc. Furthermore, initiating an exercise with free weights and weight machines can create undue strain on a user's body, since the force applied by such equipment acts as a step function—jumping from zero to the full resistance. Perhaps more importantly, traditional resistance training equipment is usually designed for specific exercises or specific exercise modes only, requiring an individual to own a plurality of equipment in order to access a variety of well-rounded exercises.

More recently, ‘smart’ exercise machines have been developed that claim to offer a number of different exercises in a single machine. These machines commonly operate by providing resistive forces through electronic motors, which may be adjusted to the user's strength level. However, the exercise machines disclosed by the prior art have consistently failed to provide a range of exercise modes or can provide some modes but fail in others. Moreover, such machines tend to be limited in the amount of force they produce; they are usually unwieldy and difficult to install or transport; and many fail to provide adequate safety measures for the user. Finally, neither traditional resistance training equipment nor newer exercise machines offer feedback regarding both user form and user balance during workouts.

Accordingly, there remains a need in the art for software to control a resistance training machine that is capable of implementing a large number of exercise modes, including at least isotonic and isokinetic exercises; that is capable of supplying high levels of resistive force; and that may provide feedback on user form and user balance throughout each exercise.

### SUMMARY OF THE INVENTION

Provided herein are Methods and Systems for Controlling Resistance Training Machine.

The methods, systems, and apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed.

Accordingly, it is an object of the invention not to encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. § 112, first paragraph) or the EPO (Article 83 of the EPC), such that Applicants reserve the right and hereby disclose a disclaimer of any previously described product, process of making the product, or method of using the product. It may be advantageous in the practice of the invention to be in compliance with Art. 53(c) EPC and Rule 28(b) and (c) EPC. All rights to explicitly disclaim any embodiments that are the subject of any granted patent(s) of applicant in the lineage of this application or in any other lineage or in any prior filed application of any third party is explicitly reserved. Nothing herein is to be construed as a promise.

### BRIEF DESCRIPTION OF THE DRAWINGS

In the accompanying figures, like elements are identified by like reference numerals among the several preferred embodiments of the present invention.

FIG. 1A is a schematic flow chart of the Methods and Systems for Controlling Resistance Training Machine, according to one embodiment.

FIG. 1B is a schematic flow chart of the Methods and Systems for Controlling Resistance Training Machine, according to another embodiment.

FIG. 1C is a schematic flow chart of the Methods and Systems for Controlling Resistance Training Machine, according to another embodiment.

FIG. 2 is a hardware schematic of the schematic flow chart of the Methods and Systems for Controlling Resistance Training Machine, according to one embodiment.

FIG. 3 is a schematic of the wireless connections for the Methods and Systems for Controlling Resistance Training Machine, according to one embodiment.

FIG. 4 is a schematic of the database for the Methods and Systems for Controlling Resistance Training Machine, according to one embodiment.

### DETAILED DESCRIPTION OF THE INVENTION

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

Embodiments of the invention will now be described with reference to the Figures, wherein like numerals reflect like elements throughout. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

The use of the terms “a” and “an” and “the” and similar referents in the context of describing the invention are to be construed to cover both the singular and the plural, unless otherwise indicated herein or clearly contradicted by context. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any nonclaimed element as essential to the practice of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As used herein the term “method” refers to manners, means, techniques and procedures for accomplishing a given task including, but not limited to, those manners, means, techniques and procedures either known to, or readily developed from known manners, means, techniques and procedures by practitioners of the software and electrical arts. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### Description

The method and software for controlling a resistance training machine provides varying force and velocity levels for isokinetic and isotonic exercises, respectively, for a user. Furthermore, the method and software for controlling a resistance training machine measures and communicates form feedback and balance feedback during some or all exercises performed on the machine, thereby improving workout efficacy and safety for the user. The resistance training machine may be the one described in commonly assigned PCT application serial no. PCT/US22/47441, filed Oct. 21, 2022, herein incorporated by reference in its entirety. Generally speaking, the resistance training machine comprises a platform or base with load cells, a motor and a sensor operably coupled to cables, cables operably coupled to a pulley system, a controller operatively coupled to the sensors, load cells, motors, and human machine interface (HMI). The method of providing feedback on user form and user balance while exercising on the resistance training machine comprise providing resistance supplied by the motors to perform an isokinetic exercise or an isotonic exercise. During the exercise, the method receives position data as a function of time from the motor, and the main module receive current, torque, and/or force data as a function of time from the motor. In an embodiment, the main module receives force data, weight data, force distribution data and/or weight distribution from the load cells.

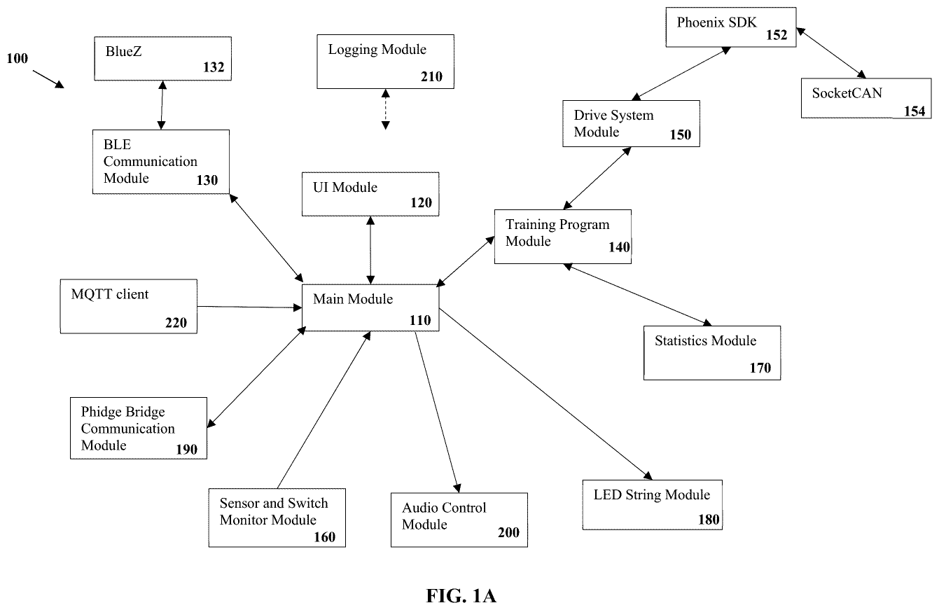

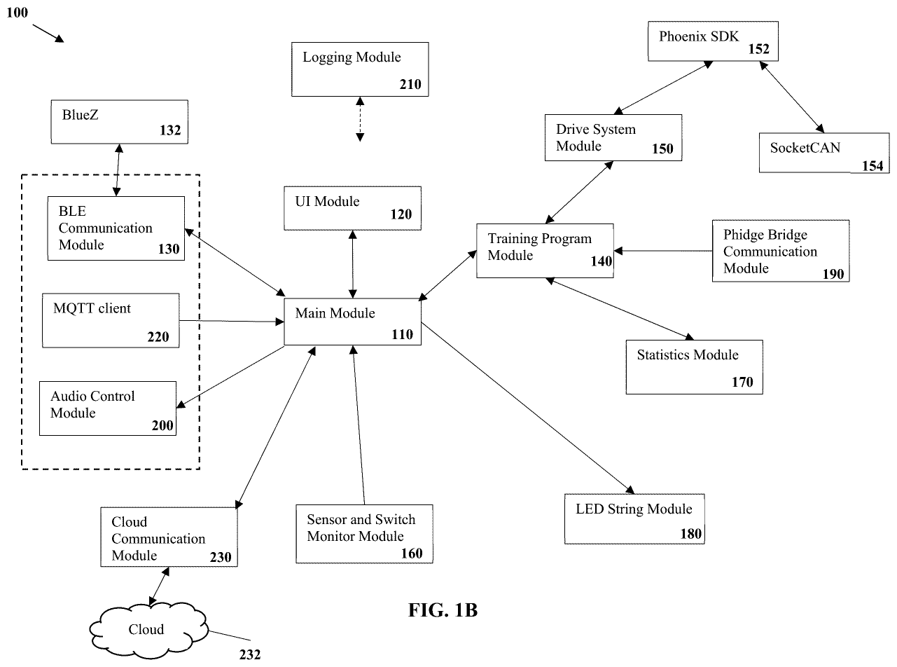

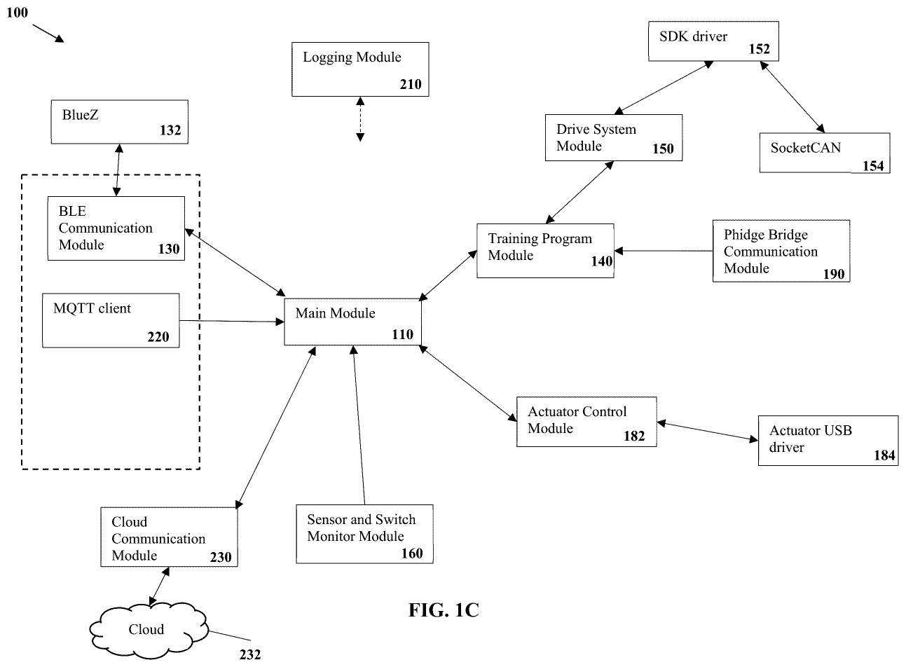

As shown in FIGS. 1A-1B, the method and software for controlling an isokinetic and isotonic exercise machine 100 comprises a main module 110 operable and communicable with a plurality of modules. The main module 110 is operable and communicates with a UI module 120, a BLE communication module 130, a Training program module 140, a drive system module 150, a sensor and switch monitor module 160, a statistics module 170, a LED string control module 180, a Phidge Bridge communication module 190, an audio control module 200. A Logging Module 210 is communicable with all the modules and logs all the events from all modules to terminal and file, logging and providing training history on request. An MQTT client 220 is operable and communicable with the main module 110 to get information from Puck.js. An alternative embodiment is shown in FIG. 1B, the main module 110 is operable and communicates with the UI module 120, while the BLE communication module 130, MQTT client 220, and the audio control module 200 are controlled and communicable via wireless or a Bluetooth interface. An alternative embodiment is shown in FIG. 1C, the main module 110 is operable and communicates with an Actuator control module 182. The actuator control module 182 is operable and communicates with an actuator driver 184 that controls an actuator to select between 2 gear ratios. In one embodiment, the gear ratios are between about 5:1 and about 25:1. The main module 110 is operable and communicates with the Training program module 140 while the Phidge Bridge communication module 190 operates and communicates with the Training program module 140. The main module 110 is operable and communicates with a Cloud communication module 230 that communicates with a cloud server 232. The drive system module 150, the sensor and switch monitor module 160, the statistics module 170, the LED string control module 180 and a Cloud Communication module 230 are included in the alternative embodiment.

The alternative embodiment in FIG. 1C includes an SDK driver 152, and does not include statistics module the 170, the UI module 120, the LED string module 180, and the audio control module 200. The alternative embodiment in FIG. 1C does not include Puck.js buttons but includes a custom BLE hardware device.

The main module 110 is the main loop and device's state machine controlling the operation and software of the method 100. The main module 110 reads out a plurality of settings on the exercise machine startup. The main module 110 stores the calibration data. The main module 110 distributes the sensors data to the UI module 120 and the BLE communication module 130. The main module 110 manages the haptic or button presses received from BLE enabled buttons. The main module sets the color and glowing mode from the LED string control module 180. The main module 110 manages the information received from Phidge Bridge communication module 190. The main module 110 calls methods from Audio control module 200 when needed. The main module operates a plurality of states including an Initialize state, a Calibration state, a Workout state, a Stop state, an Idle state, a Pull in Slack state. In one embodiment, there is a tracking motor current state and a hall sensor check state.

The initialize state is configured to ramp up to or ramp down from a given velocity, e.g. during an initial or ending phase of an isokinetic exercise; or the motor may be configured to ramp up to or ramp down from a given force, torque, or current, e.g. during an initial or ending phase of an isotonic exercise. In the same or other embodiments, the motor may be configured to implement independent S-curve smoothing; and/or may be configured to operate at constant accelerations, operate within minimum and/or maximum velocities, operate within minimum and/or maximum accelerations, and yet other kinematic controls, which further improve a perceived smoothness and overall safety for the user.

The Calibration state is calibrating one or more exercises, wherein each exercise having a relative beginning position and a relative end position. More specifically, the main module 110 selects the relative beginning position by extending or retracting one or both cables to a first position, without resistance, and allows for the holding the first position for 2-5 seconds. The main module 110 may then select the relative end position by extending or retracting one or both cables to a second position, without resistance, and allowing for the holding the second position for 2-5 seconds. In some embodiments, it may be understood that the ‘relative’ beginning and ‘relative’ end positions may be used merely to define a length of travel for the cable. For example, various exercises may be started from any cable position, and the difference between the calibrated beginning and end positions may be used to determine a length of travel until the end position of the exercise. It may further be appreciated that some or all exercises may require calibration of only one of or both of the left and right cables. In some embodiments, the main module 110 is programmed to include a Calibration Mode incorporating the above steps, where said steps may be facilitated through the display, an input mechanism, or a database. In the same or other embodiments, recalibration of an exercise may be performed at any time by entering the Calibration state. The Calibration state may optionally sense the attachment or detachment of an accessory to one or both cables.

The workout state selects an exercise from among the one or more calibrated exercises. In various embodiments, the main module 110 allows the user to select to perform the exercise using the left cable only, the right cable only, or using both the left and right cables; the user may select a number of repetitions for the exercise; and/or the user may select an exercise mode, such as an isokinetic mode or an isotonic mode. If an isokinetic mode is selected, the user may further select a constant velocity to be outputted by the machine; or, if an isotonic mode is selected, the user may further select a constant force to be outputted by the machine.

The Stop state is the main module activates the sensor and switch module to stop the cables and the motors.

The Pull in Slack state operates the main module to retract the cables when no longer in use. Accordingly, the main module 110 operates the motor to retract the cable to the docking position at a minimum force or minimum velocity if/when certain conditions are met. According to an embodiment, the Pull-In Slack state may be activated by the main module 110 if/when the cable is not in the docking position and no resistance has been detected by the machine controller for between 5 and 15 seconds and, more preferably, between 8 and 12 seconds. In the same or other embodiments, the Pull-in Slack state may be deactivated by the main module 110 (and the retraction ceased) if, during retraction, a resistance is detected in the cables. It may be understood that Pull-in Slack state may also be activated by the main module 110 in other circumstances, and may be activated for a single cable at a time or both cables concurrently.

In some embodiments, the main module 110 may further feature any number of safety protocols designed to protect the user and/or the machine when dangerous activity is detected or when certain limits are exceeded. In such embodiments, the main module 110 enters an Idle state, wherein no resistance is detected by one or both motors. In the same or other embodiments, the Idle state may be followed by the Pull-in Slack state in order to reset the machine. For example, the main module enters the Idle state if, in the course of an exercise: a force exceeding between 300 and 700 pounds or, more preferably, 500 pounds is detected on either motor; a repetition exceeds between 6 and 14 seconds or, more preferably, 10 seconds; or either or both knobs are within between 0.5 and 2 inches or, more preferably 1 inch of the docking position. In such circumstances, the main module 110 may instruct the motor to cease providing resistance, followed by a brief pause, and then begin retraction through the Pull-in Slack mode. As discussed above, the main module communicates with the load cells to enable additional safety protocols, in combination with or independent of the above conditions. For example, the Idle state may be activated by the main module 110 if the cable is not in the docking position and one or more load cells detect an unsafe user balance, or if the user is standing to close to an edge of the base.

The tracking motor current state tracks the current provided in the motor modules and operates the main module for ensuring calibration and safety protocols are maintained. The hall sensor check state operates to ensure the platform sensors and the handle sensors are operating and able to turn off the machine.

### Modules

The UI module 120 handles UI transitions and user actions. The UI module 120 sends important events to the main module 110. The UI module sends a selected training program, a request training history and the like. In one embodiment, the UI API includes data communicable with an API for a cloud communication. In some embodiments, the UI module 120 generate a graphic user interface (GUI) displayed by the HMI. The GUI is configured by the UI module to receive a user's selection of exercise type, exercise mode, exercise velocity, exercise force, exercise repetitions etc. Furthermore, the UI module may display feedback regarding the user's form and balance, and/or the GUI may alert the user when unsafe practice are detected. For example, during an ongoing exercise, the UI module may display a visual representation on the HMI as a simulated user form, a relative position of the cable, a force distribution between the left and right sides of the user's body, a weight distribution across the base, a simulated user stance, and yet other possibilities. Indeed, no limitation is intended herein for the means by which the UI module may receive selections from the user, nor for the means by which feedback on user balance and form may be displayed by the UI module.

The BLE communication module 130 handles the connection third party devices. In one embodiment, BLE communication module connects with an Android Tablet or Phone. The BLE communication module 130 updates the service and characteristics data. In one embodiment, the BLE communication module 130 communicates with a BlueZ 132, headphones, or third party devices. The third party devices may include software applications (so-called apps) for smart-phones, personal digital assistants, music players, watch based devices, portable (laptop, tablet, etc.) computers, etc. can provide various visual and audio feedback and cues to a user. Feedback can be provided by way of audio, tactile, or electronic indicator, or by way of a connection to a smart-phone, personal digital assistant, portable (laptop, tablet, etc.) computer, etc. The sensors can also be integrated into various forms of sports or safety equipment, such as a soccer shin pad or football shoulder pads. The sensors can also be integrated into various devices configured to be attached to or placed within a shoe.

The training program module 140 communicates and controls the drive system module 150 and the statistics module 170. The training program module 140 runs selected training programs taking into an account mode and the number of motors involved. The account mode comprises an isotonic exercise training mode, an isokinetic exercise training mode, or a pull in slack mode. The number of motors may be one motor, two motors, or more than two motors. The training program module 140 controls the transitioning between a plurality of training sets. The training program module 140 request sensors data within a pre-defined period and passes the sensor data to the statistics module 170 and main module 110.

The data and analysis by the controller includes the type of exercise being performed, the mode of the exercise (e.g. isokinetic or isotonic), the specified velocity or force levels outputted by the motors, the number of repetitions, the motion profile executed by the motor, and yet other factors; and may further depend on a sampling frequency of the motor and/or the controller. For one embodiment, during an isokinetic and isometric exercise, the controller may utilize the position feedback from the motors to determine a kinematic motion of the user throughout his or her range of motion. Likewise, during an isotonic and isometric exercise, the controller may utilize the current feedback from the motors to determine a force applied by the user throughout his or her entire range of motion. In the above embodiments, it may be determined that the user's physical motion or force output is sufficiently balanced between the left and right sides of the body, or alternatively, that an unbalanced distribution has occurred. Such analysis by the main module may then be communicated to the user through the display and/or, in some circumstances, may lead to the activation of certain safety protocols, such as the Safe state.

The drive system module 150 is operable and communicates with the training program module 140 and a Phoenix SDK 152. The drive system module 150 sets the mode of the drive system. In one embodiment, the drive system module 150 sets and removes the resistance force for both motors. The drive system module 150 sets the target velocity. The drive system module 150 sets and checks the target distance for each repetition. The drive system module 150 provides the sensors data upon request. The Phoenix SDK is operably coupled and communicable with a socketCAN 154. The Phoenix SDK provides the programming framework for controlling the hardware contained in the drive system. The socket can The SocketCAN is an implementation of CAN protocols (Controller Area Network) for Linux. CAN is a networking technology and SocketCAN uses the Berkeley socket API, the Linux network stack and implements the CAN device drivers as network interfaces. The CAN socket includes an API.

After an exercise and its parameters are selected, the user may then begin the exercise and move the cable to a beginning position, without resistance from the motors. More specifically, the user may enter a GO command into the UI module, after which a period of time is allocated for the user to freely move the cable to the desired beginning position, such as between about 1 and about 10 seconds and, more preferably, between about 4 and about 6 seconds. As previously discussed, this beginning position is used by the main module to define the end position of the exercise, based on the difference between the relative beginning and the relative end that was calibrated for the exercise.

The drive system module drives the motor to ramp up the cable to a constant velocity, e.g. for an isokinetic exercise, or ramp up the cable to a constant force, e.g. for an isotonic exercise. The user may then perform a repetition of the exercise at the constant velocity or force. Near the end position of the motion, the drive system module drives the motor to ramp down the cable from the constant velocity to zero or a minimum velocity (block 6111), e.g. for the isokinetic exercise; or ramp down the cable from the constant force to zero or a minimum force, e.g. for an isotonic exercise. Finally, the training module may repeat the exercise for a selected number of repetitions, and the workout completed. In various embodiments, specific ramp up and ramp down times may be selected by the user, set by the manufacturer, and/or changed according to the associated exercise; and may be set to between about 0.5 and about 3.0 seconds, and more preferably, between about 1.0 and about 2.0 seconds. Furthermore, additional smoothing, such as S-curve smoothing, may be applied to the motion profile of the cable during either ramp up or ramp down procedures.

The statistics module 170 is operably with the training program module and the statistics module 170 collects sensors data and calculates the statistical data. The statistical data includes the minimum repetition, the maximum repetition, the average user force, the repetition time, the set average force and total time. In one embodiment, the statistics module is operable and communicable with a database to log all statistics and personal data. In one embodiment, the database is a cloud based server running NoSQL or SQLite. It may be understood, however, that the statistics module may track data in only one or both cables, track data related to functional symmetry, i.e. alternating left and right cables; track data relating to a specific number or range of repetitions; track data for different exercises in a specific exercise mode only; track data on different exercises in a specific number or range of velocity and force; and/or track data for different exercises preprogrammed into the main module. Indeed, no limitation is intended herein for the specific data tracked by the statistics module related to exercise type, handedness, symmetry, repetitions, exercise mode, and/or range of exertions that may be provided by the machine.

The LED string module 180 is controlled by the main module 110 and sets the RGB color, ON/OFF the lights, Blink, fade lights depending on the Device status (uses some state machine for LED indication).

The audio control module 200 is controlled by the main module 110 and plays audio using some schedule or commands from the Main module, change volume level, etc. The audio control module 200 play audio or is coupled by the BLE for headphone playback.

The sensor and switch monitor module 160 is operable and communicable with the main module 110. The sensor and switch monitor module 160 reads the hall sensors and the switch status and reports to Main module. In one embodiment, the sensor and switch monitor module 160 is combined with the main module 110. In one embodiment, the sensor and switch module 160 reads both sets of hall sensors, the handle sensors and the platform folding sensors. In one embodiment, the sensor and switch module 160 manages the logic signals similarly by reading General-Purpose Input/Output (GPIOs).

The Phidge Bridge communication module 190 is operable and communicable with the main module 110. The Phidge Bridge communication module 190 reads out data from 4 load cells, calculates weight and position by weight disbalancing, and reports these data to the Main module. In one embodiment, the Phidge Bridge communication module 190 is only operable during a workout loop or a setup loop. In another embodiment, the training program module 140 reads out data from 4 load cells, calculates weight and position by weight disbalancing, and reports these data to the Main module. The Phidge Bridge communication module 190 is operable outside the Training program module for configuration/calibration purposes.

The MQTT client 220 gets information from Puck.js and one of the options to communicate with Puck.js BLE devices mounted into the handles. The MQTT client 220 does not conflict with BLE communication module by using mutex, and communicates directly with Puck.js device. The MQTT client 220 is any device (from a micro controller up to a full-fledged server) that runs an MQTT library and connects to an MQTT broker over a network.

The main module generates feedback pertaining to the user's form from some or all of the above data received by the drive system module, MQTT client, and the Phidge Bridge communication module; and, the main module generates feedback pertaining to the user's balance from some or all of the above. Finally, the main module may display the user form and user balance feedback through the UI module through any number of means known in the art, such as but not limited to a GUI, graphs, charts, tables, simulations, audio cues, and the like. In some embodiments, the main module may specifically generate a visual representation of the user's form and balance, such as but not limited to a 3D model, a color-coded display of active muscle groups, a distribution of left-side and right-side forces, and many other possibilities, which may improve a comprehension and/or enjoyment for the user. As previously discussed, no limitation is intended herein for the algorithms or strategies by which insights may be extracted from the underlying data.

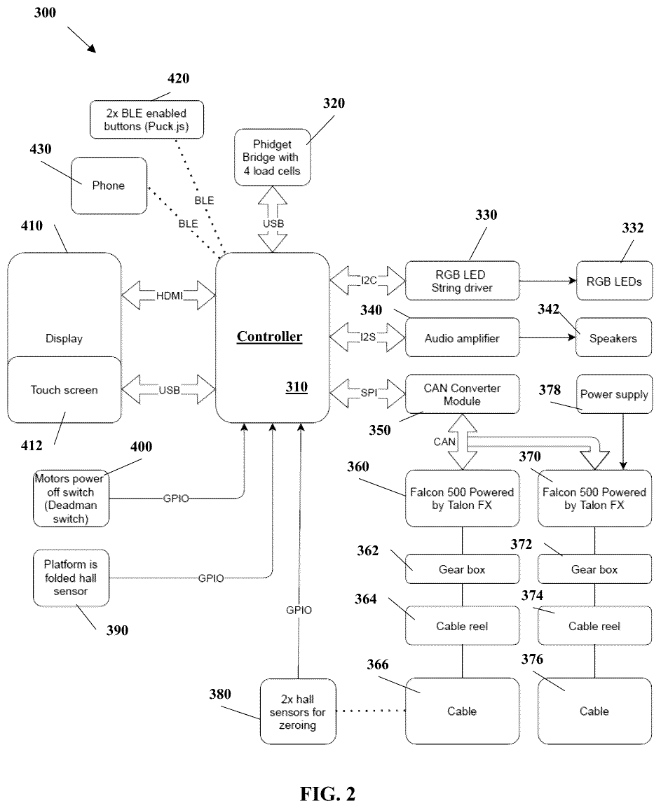

As shown in FIG. 2, the method and software for controlling the isokinetic and isotonic exercise machine 300 controls a number of hardware features and electronic components in the resistance training machine, which improve its ease of use and its customizability. In the embodiment, the method and software for controlling the isokinetic and isotonic exercise machine comprises a controller 310, a Phidget Bridge with a plurality of load cells 320, a LED string driver 330, an audio amplifier 340, a CAN Converter module 350, a first motor/sensor 360, a second motor/sensor 370, a hall sensor for zeroing 380, a motor power off switch 390, a platform hall sensor 400, a Display 410, and wireless buttons 420. The controller 310 may be, without limitation, a microcontroller, gateway computer, field-programmable gate array (FPGA), application-specific integrated-circuit (ASIC), a single-board computer (SBC), or comparable computing device configured to interface with at least the first motor/sensor 360, a second motor/sensor 370, the Phidget Bridge with a plurality of load cells 320, and the display 410. The controller 310 may receive electrical power from the power supply and may comprise at least a processor, a memory in the form of a non-transitory storage medium, and a communication bus (not shown). A single-board computer (SBC) is a complete computer built on a single circuit board, with microprocessor(s), memory, input/output (I/O), wireless or Bluetooth signal/receiving components, and other features required of a functional computer.

The Phidget Bridge with a plurality of load cells 320 is an electric board measuring the output from a load cell. The load cells send the load data rate and gain values, which are configured and analyzed in the controller 310. A load cell is a force sensing module with small elements called strain gauges mounted in precise locations on the structure. Load cells measure a specific force, and ignore other forces being applied. The electrical signal output by the load cell is very small and requires specialized amplification. The Phidget Bridge perform all the amplification and measurement of the electrical output from the load cell. The load cell may be, without limitation, a single point load cell, digital load cell, beam load cell, canister load cell, and the like, and may operatively measure a force, force distribution, weight and/or weight distribution of a user working out on top of the platform. In the embodiment shown, the machine may specifically comprise four load cells spaced evenly across the four quadrants of the base, although other quantities and distributions are also possible. And in another embodiment, the load cells may specifically be placed in a middle section of the platform.

The LED string driver 330 is operably connected to the controller 310 and the LEDs 332. In one embodiment, the LED's are red, green, blue LED's or a combination thereof. The audio amplifier 340 is operably connected to the controller 310 and a speaker 312.

The CAN converter module 350 is operably connect to the controller 310 and the first motor/sensor 360 and the second motor/sensor 370. The first motor/sensor 360 is operably coupled to a first gear box 362, and the first gear box 362 is operably coupled to a first cable reel 364, and the first cable reel is operably coupled to a first cable 366. The second motor/sensor 370 is operably coupled to a second gear box 372, and the second gear box 372 is operably coupled to a second cable reel 374, and the second cable reel 374 is operably coupled a second cable 376. The first motor/sensor 360 and the second motor/sensor 370 are powered by a power supply 378. The first cable 366 and the second cable 376 are operably coupled to the hall sensors 380 for zeroing. The hall sensors 380 are operably coupled to the controller 310.

The platform hall sensor 390 is operably coupled with the controller 310 and senses when the platform is folded in the down position or the up position. The motor power switch 400 is operably coupled with the controller 410 and switches off the first motor/sensor 360 and the second motor/sensor 370 upon a safety signal. The display 410 is operably coupled with the controller 310 and the display 410 includes a touch screen, HMI, or an Application Programming Interface (API) for the user to input data, information, and training programs. A phone 430 may be operably coupled with the controller 310 via wireless technology, such as Bluetooth. The wireless buttons 420 are operably coupled with the controller 310 and send the safety signal as to activate the motor power off switch 400.

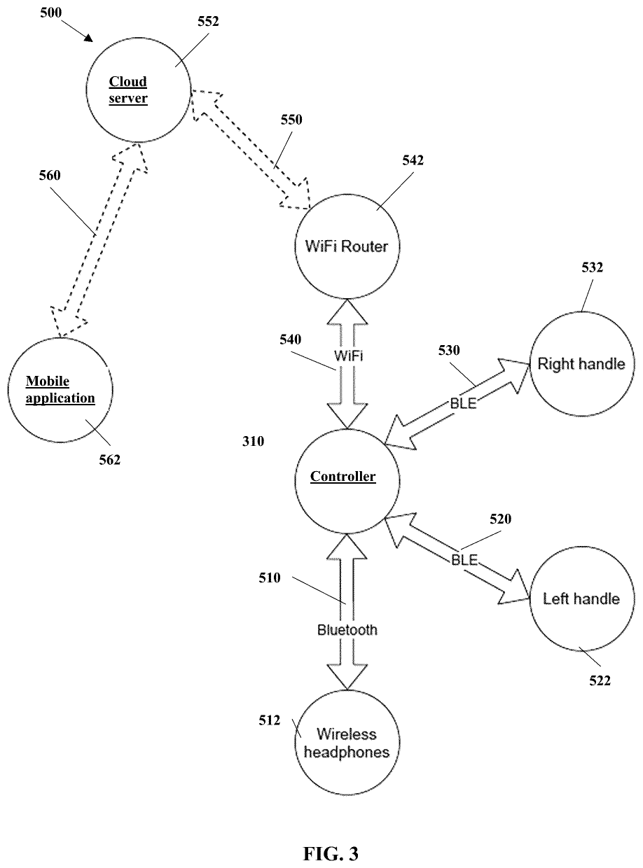

As shown in FIG. 3, the network 500 for the method and software for controlling the isokinetic and isotonic exercise machine comprises a first wireless connection 510 from the controller 310 to a wireless headphone 512, a second wireless connection 520 from the controller 310 to a left handle 522, a third wireless connection 530 from the controller 310 to a right handle 532, a fourth wireless connection 540 from the controller 310 to a WiFi router 542, a fifth wireless connection 550 from the WiFi router 542 to a cloud server 552, and a sixth wireless connection 560 from the cloud server 552 to a mobile application 562. The wireless connections may be by Bluetooth or WIFI protocols.

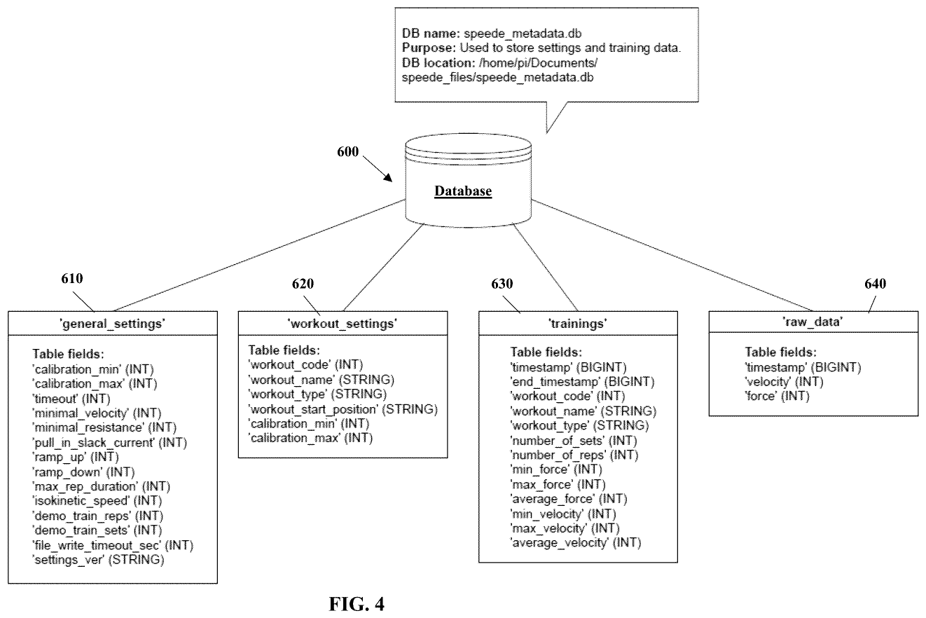

As shown in FIG. 4, the database 600 store settings and training data collected from the statistics module. The database 600 comprises four fields of data, a general settings 610, a workout setting 620, a training setting 630, and a raw data setting 640. Once the device has been calibrated, the operator can have an access to the user database managed by the Software. He can either select an existing user or enter a new user in the database. Once the user has been selected in the database, the operator can have access to the “exercise menu’ where he can specify the exercises to be performed by the user and set the corresponding parameters. It is important to note that the operator is able to define exercises in advance for future exercise sessions. For each user, and for each exercise type the operator can store in the database the mechanical settings used to position the user.

The general settings 610 include a minimum calibration setting, a maximum calibration setting, a timeout setting, a minimal velocity setting, a minimal resistance setting, a pull in slack current setting, a ramp up setting, a ramp down setting, a max repetition duration setting, a isokinetic speed setting, a demo training repetition setting, a demo training sets setting, a timeout second setting, and a settings verification. The workout settings 620 include a workout code, a workout name, a workout type, a workout start position, a calibration minimum, and a calibration maximum. The training 630 include a timestamp, an end timestamp, a workout code, a workout name, a workout type, a number of sets, a number of repetitions, a minimum force, a maximum force, an average force, a minimum velocity, a maximum velocity, and an average velocity. The raw data 640 includes a timestamp, a velocity, and force.

The method and software for controlling the isokinetic and isotonic exercise machine may implement algorithms and/or additional processes which perform an analysis on the data from the database and provide user form feedback and user balance feedback for future use. No limitation is intended herein for the type and number of data from the database which may be derived by the machine controller, nor for the algorithms and mechanisms by which feedback is extracted from the motors and the subsequent analysis performed from the database.

In some embodiments, the above feedback information may also be used to activate safety protocols. If unsafe user activity is detected, the controller may enter a Non-workout Mode, wherein the motors may cease to apply resistance. In the same or other embodiments, appropriate alerts, such as visual or audio cues, may further be communicated to the user through the UI module. However, it should be understood that other safety triggers and other resulting actions are also possible and envisioned.

Furthermore, it should be understood that some or all of the above steps may be obviated, may be performed in a different order, and/or may be performed concurrently, without departing from the scope of the present disclosure.

### System

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Software includes applications and algorithms. Software may be implemented in a smart phone, tablet, or personal computer, in the cloud, on a wearable device, or other computing or processing device. Software may include logs, journals, tables, games, recordings, communications, SMS messages, Web sites, charts, interactive tools, social networks, VOIP (Voice Over Internet Protocol), e-mails, and videos.

In some embodiments, some or all of the functions or process(es) described herein and performed by a computer program that is formed from computer readable program code and that is embodied in a computer readable medium. The phrase “computer readable program code” includes any type of computer code, including source code, object code, executable code, firmware, software, etc. The phrase “computer readable medium” includes any type of medium capable of being accessed by a computer, such as read only memory (ROM), random access memory (RAM), a hard disk drive, a compact disc (CD), a digital video disc (DVD), or any other type of memory.

All publications and patent applications mentioned in this specification are herein incorporated by reference to the same extent as if each individual publication or patent application was specifically and individually indicated to be incorporated by reference.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A Methods For Controlling Resistance Training Machine, comprising the steps:
a. controlling a resistance training machine to measure and communicate form feedback and balance feedback during some or all exercises performed on the machine by a drive system module, wherein the resistance training machine comprises a platform or base with load cells, a motor and a sensor operably coupled to cables, cables operably coupled to a pulley system, a controller operatively coupled to the sensors, load cells, motors, and human machine interface (HMI);
b. providing resistance supplied by the motors to perform an isokinetic exercise or an isotonic exercise by receiving position data as a function of time from the motor, and the main module receive current, torque, and/or force data as a function of time from the motor, the main module receives force data, weight data, force distribution data and/or weight distribution from the load cells; and
c. operably coupling a main module with a plurality of modules including a BLE communication module, a Training program module, the drive system module, a sensor and switch monitor module, an actuator control module, a Phidge Bridge communication module, a Logging Module, and an MQTT client.

2. The method of claim 1, further comprising the plurality of modules communicating with the Logging Module to logs all the events from all modules to terminal and file, logging and providing training history on request; and the MQTT client is operable and communicable with the main module to get information from wireless buttons.

3. The method of claim 2, further comprising:
a. Operating the main module with the BLE communication module, the MQTT client, and controlling the BLE communication module, MQTT client via wireless interface;
b. Operating the main module with the Training program module and the Phidge Bridge communication module operates with the Training program module;
c. Operating the main module that communicates with a cloud server; and
d. Operating the main module with the drive system module and a sensor and switch monitor module.

4. The method of claim 3, further comprising reading out a plurality of settings by the main module; storing a calibration data on the system startup; distributing the sensors data to the main module and the BLE communication module by the main module; managing the haptic or button presses received from a plurality of BLE enabled buttons by the main module; setting a color and glowing mode from the main module; managing the information received from Phidge Bridge communication module by the main module; calling methods from main module upon request by the main module; operating a plurality of states including an Initialize state, a Calibration state, a Workout state, a Stop state, an Idle state, a Pull in Slack state, a tracking motor current state, and a hall sensor check state.

5. The method of claim 4, wherein the initialize state is configured to ramp up to or ramp down from a given velocity, such as during an initial or ending phase of an isokinetic exercise; or the motor may be configured to ramp up to or ramp down from a given force, torque, or current, such as during an initial or ending phase of an isotonic exercise; configuring the motor to implement independent S-curve smoothing or configuring the motor to operate at constant accelerations, operate within minimum and/or maximum velocities, operate within minimum and/or maximum accelerations, and kinematic controls to improve a perceived smoothness and overall safety for the user.

6. The method of claim 5, wherein the Calibration state is calibrating one or more exercises, wherein each exercise having a relative beginning position and a relative end position; selecting the relative beginning position by extending or retracting one or both cables to a first position, without resistance, and allows for the holding the first position for 2-5 seconds by the main module; selecting the relative end position by extending or retracting one or both cables to a second position, without resistance, by the main module; and allowing for the holding the second position for 2-5 seconds.

7. The method of claim 6, wherein the workout state selects an exercise from among the one or more calibrated exercises; allowing the user to select to perform the exercise using the left cable only, the right cable only, or using both the left and right cables; selecting a number of repetitions for the exercise; selecting an exercise mode, such as an isokinetic mode or an isotonic mode if an isokinetic mode is selected, then selecting a constant velocity to be outputted by the machine; if an isotonic mode is selected, then selecting a constant force to be outputted by the machine.

8. The method of claim 7, wherein the Stop state is the main module activates the sensor and switch module to stop the cables and the motors.

9. The method of claim 8, wherein the Pull in Slack state operates the main module to retract the cables when no longer in use; operating the motor to retract the cable to the docking position at a minimum force or minimum velocity if/when certain conditions are met.

10. A computer program product for a Resistance Training Machine, the computer program product comprising computer-readable instruction means stored on a non-transitory computer-readable medium that are executable by a computer having a processor for causing the processor to perform operations of:
a. controlling a resistance training machine to measure and communicate form feedback and balance feedback during some or all exercises performed on the machine, wherein the resistance training machine comprises a platform or base with load cells, a motor and a sensor operably coupled to cables, cables operably coupled to a pulley system, a controller operatively coupled to the sensors, load cells, motors, and human machine interface (HMI);
b. providing resistance supplied by the motors to perform an isokinetic exercise or an isotonic exercise by receiving position data as a function of time from the motor, and the main module receive current, torque, and/or force data as a function of time from the motor, the main module receives force data, weight data, force distribution data and/or weight distribution from the load cells; and
c. operably coupling a main module with a plurality of modules including an UI module, a BLE communication module, a Training program module, a drive system module, a sensor and switch monitor module, a statistics module, a LED string control module, a Phidge Bridge communication module, an audio control module, a Logging Module, and a An MQTT client.

11. The computer program product of claim 10, further comprising the plurality of modules communicating with the Logging Module to logs all the events from all modules to terminal and file, logging and providing training history on request; and the MQTT client is operable and communicable with the main module to get information from the wireless buttons.

12. A computer program product for a Resistance Training Machine, the computer program product comprising computer-readable instruction means stored on a non-transitory computer-readable medium that are executable by a computer having a processor for causing the processor to perform operations of:
a. Operating a main module with an UI module, a BLE communication module, a MQTT client, and an audio control module, and controlling the UI module, BLE communication module, MQTT client, and the audio control module via wireless interface;
b. Operating the main module with a Training program module and a Phidge Bridge communication module operates with the Training program module;
c. Operating the main module a Cloud communication module that communicates with a cloud server; and
d. Operating the main module with a drive system module, a sensor and switch monitor module, a statistics module, a LED string control module.

13. The computer program product of claim 12, further comprising reading out a plurality of settings by the main module; storing a calibration data on the system startup; distributing the sensors data to the UI module 120 and the BLE communication module by the main module; managing the haptic or button presses received from a plurality of BLE enabled buttons by the main module; setting a color and glowing mode from the LED string control module by the main module; managing the information received from Phidge Bridge communication module by the main module; calling methods from Audio control module upon request by the main module; operating a plurality of states including an Initialize state, a Calibration state, a Workout state, a Stop state, an Idle state, a Pull in Slack state, a tracking motor current state, and a hall sensor check state.

14. The computer program product of claim 13, wherein the initialize state is configured to ramp up to or ramp down from a given velocity, such as during an initial or ending phase of an isokinetic exercise; or the motor may be configured to ramp up to or ramp down from a given force, torque, or current, such as during an initial or ending phase of an isotonic exercise; configuring the motor to implement independent S-curve smoothing or configuring the motor to operate at constant accelerations, operate within minimum and/or maximum velocities, operate within minimum and/or maximum accelerations, and kinematic controls to improve a perceived smoothness and overall safety for the user.

15. The computer program product of claim 13, wherein the Calibration state is calibrating one or more exercises, wherein each exercise having a relative beginning position and a relative end position; selecting the relative beginning position by extending or retracting one or both cables to a first position, without resistance, and allows for the holding the first position for 2-5 seconds by the main module; selecting the relative end position by extending or retracting one or both cables to a second position, without resistance, by the main module; and allowing for the holding the second position for 2-5 seconds.

16. The computer program product of claim 15, wherein the workout state selects an exercise from among the one or more calibrated exercises; allowing the user to select to perform the exercise using the left cable only, the right cable only, or using both the left and right cables; selecting a number of repetitions for the exercise; selecting an exercise mode, such as an isokinetic mode or an isotonic mode if an isokinetic mode is selected, then selecting a constant velocity to be outputted by the machine; if an isotonic mode is selected, then selecting a constant force to be outputted by the machine.

17. The computer program product of claim 16, wherein the Stop state is the main module activates the sensor and switch module to stop the cables and the motors.

18. The computer program product of claim 17, wherein the Pull in Slack state operates the main module to retract the cables when no longer in use; operating the motor to retract the cable to the docking position at a minimum force or minimum velocity if/when certain conditions are met.
